(19) United States
(12) Patent Application Publication
(10) Pub. No.: US 2025/0109252 A1
(43) Pub. Date: Apr. 3, 2025

(54) SILSESQUIOXANE DERIVATIVE, CURABLE COMPOSITION, HARD COAT AGENT, CURED PRODUCT, HARD COAT, AND BASE MATERIAL

(71) Applicant: TOAGOSEI CO., LTD., Minato-ku, Tokyo (JP)

(72) Inventors: Yoshiaki IWASE, Nagoya-shi, Aichi (JP); Naomasa FURUTA, Nagoya-shi, Aichi (JP); Narumi OZEKI, Nagoya-shi, Aichi (JP)

(21) Appl. No.: 18/715,390

(22) PCT Filed: Dec. 1, 2022
(86) PCT No.: PCT/JP2022/044462

§ 371 Date: May 31, 2024

(30) Foreign Application Priority Data
Dec. 1, 2021 (JP) 2021-195433

(51) Int. Cl. C08G 77/04; C08F 230/08; C08K 5/07; C09D 7/65

(52) U.S. Cl. CPC C08G 77/045; C08F 230/085; C08K 5/07; C09D 7/65; C08G 2150/00

(57) ABSTRACT

A silsesquioxane derivative represented by the following Formula (1). In Formula (1), each of R¹ and R² is independently an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms, R³ is an alkyl group having from 1 to 6 carbon atoms, R⁶ is an organic group having from 2 to 12 carbon atoms and having at least one of an ethylenically unsaturated bond or a carbon-carbon triple bond, R⁷ is an alkyl group having from 1 to 10 carbon atoms, an aryl group having from 6 to 10 carbon atoms, or an aralkyl group having from 7 to 10 carbon atoms, plural R⁷'s present may be the same as or different from each other, y is a positive number, and at least one of u or v is a positive number.

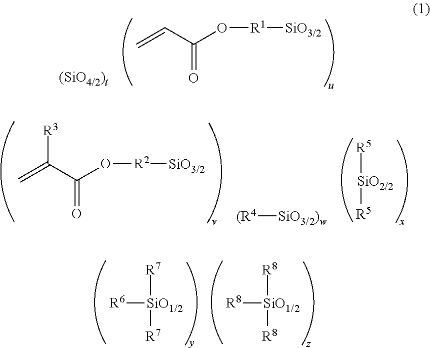

### TECHNICAL FIELD

The present invention relates to a silsesquioxane derivative, a curable composition, a hard coat agent, a cured product, a hard coat, and a base material.

### BACKGROUND ART

A hard coat agent is used in various places, such as a display and a housing, requiring hardness. Various curable compositions are known as a composition used for the hard coat agent, and for example, a polyfunctional acrylate is known.

An organic-inorganic composite composition in which an inorganic filler is mixed with an organic resin, and an organic-inorganic hybrid material in which an organic unit and an inorganic unit coexist or are chemically bonded in the order of nanometers are also attracting attention. For example, as such an organic-inorganic hybrid material, a silsesquioxane derivative is known.

As a method of forming a hard coat layer, for example, it is known that a curable composition is applied to a base material using various known application methods, and then the applied curable composition is cured by irradiation with active energy rays such as ultraviolet rays. In a case in which the base material is film-shaped, a roll-to-roll coating method and a curing method can be used. It is known that a nanoimprint method can also be applied to form a hard coat layer.

For example, Patent Literature 1 discloses a composition for forming a hard coat layer, containing a polyorganosilsesquioxane having a siloxane constitutional unit containing an oxetanyl group and a siloxane constitutional unit containing an epoxy group, and a polymerization initiator.

Patent Literature 2 discloses a polysiloxane including from 1 to 10 mol % of a dialkoxysilane containing at least one of an alkyl group having from 1 to 12 carbon atoms or an aryl group having from 6 to 20 carbon atoms, and from 90 to 99 mol % of a trialkoxysilane containing a (meth)acrylic group (provided that, the total of the dialkoxysilane and the trialkoxysilane is 100 mol %), and a composition for a hard coat containing the polysiloxane.

Patent Literature 3 discloses a photocurable resin composition for imprinting, containing a polymerizable compound having a polymerizable functional group such as a (meth)acryloyl group and a siloxane bond in which a bifunctional silane is included, as a constitutional unit, more than a trifunctional silane, and a photopolymerizable initiator.
Patent Literature 1: WO 2019/188441 A
Patent Literature 2: Japanese Patent Application Laid-Open (JP-A) No. 2013-035918
Patent Literature 3: WO 2020/203472 A

### SUMMARY OF INVENTION

### Technical Problem

In the case of applying a curable composition containing a silsesquioxane derivative or the like to a base material, the curable composition and a solvent are generally mixed from the viewpoint of improving the coatability of the curable composition. However, in a case in which the curable composition contains a solvent, considering, for example, that a step of removing the solvent before curing the coating film is required, and that it is desirable to reduce the amount of the solvent used from the viewpoint of reducing the environmental load and the energy consumption, a curable composition having a low viscosity and not containing a solvent (solvent-free) is required.

In the solvent-free curable composition, it is desirable that the viscosity is low, coatability, curability, and the like are favorable, and the hardness of a cured product obtained by curing the curable composition is high. However, in a case in which the viscosity of the solvent-free curable composition is tried to be decreased, the curability of the curable composition and the hardness of a cured product obtained by curing the curable composition tend to decrease. Therefore, the viscosity of the solvent-free curable composition, and the curability of the curable composition and the hardness of the cured product have a trade-off relationship.

Patent Literature 1 describes that a hard coat film is produced as follows. First, a photocurable composition, contains a polysilsesquioxane composed only of a T unit (a unit having three O_{1/2}'s with respect to one silicon atom) obtained by hydrolysis and polycondensation of a trifunctional silane and a photopolymerization initiator, uses methyl isobutyl ketone (MIBK) as a solvent, and has a solid content concentration of 50%, is applied to a base material. Thereafter, the coating film is heated to remove the solvent and irradiated with ultraviolet rays, and the coating film is cured by further heating, thereby producing a hard coat film having a hard coat layer. The hardness of a hard coat containing a polysilsesquioxane composed only of a T unit as described in Patent Literature 1 is high. However, as described in Patent Literature 1, it is common to use a solvent in order to improve the coatability of the photocurable composition, and it is necessary to remove the solvent before curing the coating film.

Patent Literature 2 describes that a coating film is produced as follows. First, a photocurable composition, which contains a polysiloxane having a D unit (a unit having two O_{1/2}'s with respect to one silicon atom) and a T unit obtained by hydrolysis and polycondensation of a dialkoxysilane, and a trialkoxysilane having a (meth)acrylic group, and a photopolymerization initiator and is diluted with a solvent, is prepared. The prepared photocurable composition is applied to a base material and then prebaked, and then a coating film is produced using a high-pressure mercury lamp. The hardness of a cured coating film using the silsesquioxane derivative composed of the D unit and T unit described above may be decreased.

Patent Literature 3 describes that a pattern is formed on a base material as follows. First, a solvent-free photocurable resin composition for imprinting containing: (1) a polymerizable compound having a siloxane bond in which a bifunctional silane is included, as a constitutional unit, more than a trifunctional silane, (2) a polymerizable compound obtained by reacting chlorotrimethylsilane with a polymerizable compound having a siloxane bond in which a bifunctional silane is included, as a constitutional unit, more than a trifunctional silane, or (3) a polymerizable compound obtained by reacting chlorotrimethylsilane with a polymerizable compound obtained from a trifunctional silane, and a photopolymerizable initiator, is prepared. The solvent-free photocurable resin composition for imprinting is applied onto a quartz base material, and the photocurable resin composition for imprinting is cured with light irradiation in a state of being in contact with a quartz imprint mold, the imprint mold is then peeled off, thereby forming a pattern on the base material. In Patent Literature 3, in the case of using the polymerizable compound described in (1) or (2), the hardness as a cured product may be decreased, and in the case of using the polymerizable compound described in (3), there is room for improvement in terms of high viscosity and usage without a solvent.

The invention has been made in view of the above, and an object thereof is to provide a silsesquioxane derivative having a low viscosity and with which a cured product excellent in hardness can be produced, a curable composition containing the silsesquioxane derivative and a cured product obtained by curing the curable composition, a hard coat agent containing the silsesquioxane derivative and a hard coat obtained by curing the hard coat agent, and a base material including the hard coat.

### Solution to Problem

Means for solving the above problem include the following aspects.

<6> A silsesquioxane derivative, represented by the following Formula (1):

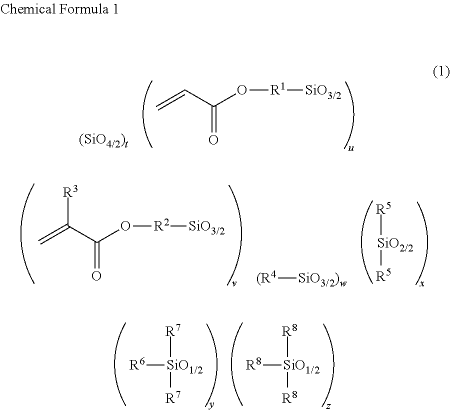

In Formula (1), each of R¹ and R² is independently an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms, R³ is an alkyl group having from 1 to 6 carbon atoms, each of R⁴ and R⁵ is independently a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms, R⁶ is an organic group having from 2 to 12 carbon atoms and having at least one of an ethylenically unsaturated bond or a carbon-carbon triple bond, each of R⁷ and R⁸ is independently an alkyl group having from 1 to 10 carbon atoms, an aryl group having from 6 to 10 carbon atoms, or an aralkyl group having from 7 to 10 carbon atoms, a plurality of R⁵'s present may be the same as or different from each other, a plurality of R⁷'s present may be the same as or different from each other, a plurality of R's present may be the same as or different from each other, parts of structures of each of R¹ to R⁸ may be independently substituted with a substituent or a halogen atom, y is a positive number, each of t, u, v, w, x, and z is independently 0 or a positive number, and at least one of u or v is a positive number.

<2> The silsesquioxane derivative according to <1>, wherein, in Formula (1), t, x, and z are 0, and 0.01≤y/(u+v+w)≤0.5 is satisfied.

<3> The silsesquioxane derivative according to <1> or <2>, wherein, in Formula (1), each of u and v is independently a positive number, and 0<v/u≤1 is satisfied.

<4> The silsesquioxane derivative according to any one of <1> to <3>, wherein a viscosity at 25° C. is from 10 mPa s to 4,000 mPa s.

<5> A curable composition, comprising the silsesquioxane derivative according to any one of <1> to <4> and a polymerization initiator.

<6> A hard coat agent, comprising the curable composition according to <5>.

<7> A cured product, obtained by curing the curable composition according to <5>.

<8> A hard coat, obtained by curing the hard coat agent according to <6>.

<9> A base material, comprising the hard coat according to <8>.

### Advantageous Effects of Invention

According to the invention, it is possible to provide a silsesquioxane derivative having a low viscosity and with which a cured product excellent in hardness can be produced, a curable composition containing the silsesquioxane derivative and a cured product obtained by curing the curable composition, a hard coat agent containing the silsesquioxane derivative and a hard coat obtained by curing the hard coat agent, and a base material including the hard coat.

### DESCRIPTION OF EMBODIMENTS

Hereinafter, modes for carrying out the invention will be described in detail. However, the invention is not limited to the following embodiments. In the following embodiments, constituent elements (including elemental steps and the like) are not necessarily indispensable unless otherwise stated. The same applies to numerical values and ranges thereof, and does not limit the invention.

In this specification, a numerical range that has been indicated by use of “to” includes the numerical values which are described before and after “to”, as a minimum value and a maximum value, respectively.

In a numerical range described in a stepwise manner in this specification, an upper limit value or a lower limit value described in one numerical range may be replaced with an upper limit value or a lower limit value described in another numerical range described in a stepwise manner. In a numerical range described in this specification, an upper limit value or a lower limit value of the numerical range may be replaced with a value shown in Examples.

In this specification, a combination of two or more preferred aspects is a more preferred aspect.

In this specification, parts of the structures of each of R¹ to R⁸ in Formula (1) may be independently substituted with a substituent or a halogen atom. For example, parts of the structures of each of R¹ to R⁸ may be independently substituted with an alkyl group, an aryl group, an aralkyl group, a vinyl group, an epoxy group, an oxetanyl group, a hydroxyl group, an amino group, an alkylamino group, an arylamino group, an aralkylamino group, an ammonium group, a thiol group, an isocyanurate group, a ureido group, an isocyanate group, a carboxy group, an acid anhydride group, or a halogen atom.

Each of R¹ to R⁸ in Formula (1) may be independently unsubstituted, and for example, R¹ to R³ or R⁶ to R⁸ (preferably, R¹ to R³ and R⁶ to R⁸) may be unsubstituted.

### [Silsesquioxane Derivative]

A silsesquioxane derivative of the invention is represented by the following Formula (1).

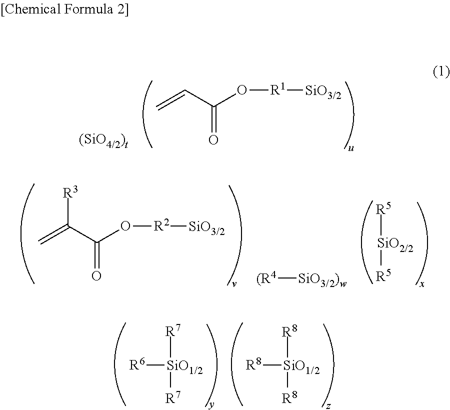

In Formula (1), each of R¹ and R² is independently an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms, R³ is an alkyl group having from 1 to 6 carbon atoms, each of R⁴ and R⁵ is independently a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms, R⁶ is an organic group having from 2 to 12 carbon atoms and having at least one of an ethylenically unsaturated bond or a carbon-carbon triple bond, each of R⁷ and R⁸ is independently an alkyl group having from 1 to 10 carbon atoms, an aryl group having from 6 to 10 carbon atoms, or an aralkyl group having from 7 to 10 carbon atoms, a plurality of R⁵'s present may be the same as or different from each other, a plurality of R⁷'s present may be the same as or different from each other, a plurality of R's present may be the same as or different from each other, parts of the structures of each of R¹ to R⁸ may be independently substituted with a substituent or a halogen atom, y is a positive number, each of t, u, v, w, x, and z is independently 0 or a positive number, and at least one of u or v is a positive number.

Respective constitutional units that can be included in the silsesquioxane derivative of the invention are referred to as constitutional units (a) to (g) as follows.

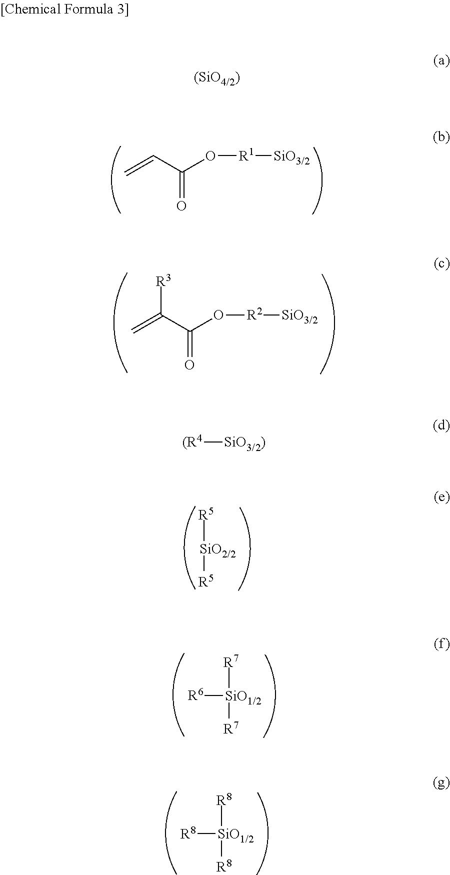

In the silsesquioxane derivative of the invention, in Formula (1), y is a positive number, each of t, u, v, w, x, and z is independently 0 or a positive number, and at least one of u or v is a positive number. That is, the silsesquioxane derivative of the invention includes at least one of the constitutional unit (b) or the constitutional unit (c), and the constitutional unit (f) among the constitutional units (a) to (g), and includes at least one of the constitutional unit (a), the constitutional unit (d), the constitutional unit (e), or the constitutional unit (g) if necessary.

In a case in which the silsesquioxane derivative of the invention includes at least one of the constitutional unit (b) or the constitutional unit (c), and the constitutional unit (f), the silsesquioxane derivative has a low viscosity and a cured product excellent in hardness can be produced with the silsesquioxane derivative.

t, u, v, w, x, y, and z in Formula (1) represent molar ratios of the constitutional units (a) to (g). In Formula (1), t, u, v, w, x, y, and z represent relative molar ratios of the constitutional units (a) to (g) that can be included in the silsesquioxane derivative represented by Formula (1). The molar ratio can be determined from NMR (nuclear magnetic resonance) analysis values of the silsesquioxane derivative of the invention. In a case in which the reaction rate of each raw material of the silsesquioxane derivative is clear or the yield is 100%, the molar ratio can be determined from the amount of the raw material charged.

For example, the molar ratio of each constitutional unit of the silsesquioxane derivative may be calculated by subjecting a sample dissolved in deuterated chloroform or the like to ¹H-NMR analysis and further subjecting the sample to ²⁹Si-NMR analysis if necessary.

The structure of the original silsesquioxane derivative may be estimated from the ratio or the like of the constitutional unit obtained by decomposing the silsesquioxane derivative into the constitutional unit with alkali or the like.

If necessary, the molar ratio of each constitutional unit of the silsesquioxane derivative may be determined by combining known methods such as mass spectrometry and infrared absorption spectroscopy (IR) analysis.

For each of the constitutional units (b) to (g) in Formula (1), only one type may be used or two or more types may be used. The sequence in Formula (1) indicates the composition of the constitutional unit, and does not mean the sequence of the silsesquioxane derivative. Therefore, the condensed form of the constitutional unit in the silsesquioxane derivative of the invention does not necessarily have to be in the sequence of Formula (1).

Hereinafter, details of the constitutional units (a) to (g) will be described.

### (Constitutional Unit (a))

The constitutional unit (a) is a Q unit including four O_{1/2}'s (two as oxygen atoms) for one silicon atom. The Q unit means a unit having four O_{1/2}'s for one silicon atom.

The proportion of the constitutional unit (a) in the silsesquioxane derivative of the invention is not particularly limited. For example, the molar ratio (t/(t+u+v+w+x+y+z)) of the constitutional unit (a) in all constitutional units is preferably 0.1 or less, more preferably 0.05 or less, and still more preferably 0, from the viewpoint of the viscosity of the silsesquioxane derivative and the hardness as a cured product. The molar ratio of 0 means that the corresponding constitutional unit is not included, and the same applies hereinafter.

### (Constitutional Unit (b))

The constitutional unit (b) is a T unit including three O_{1/2}'s (1.5 as oxygen atoms) for one silicon atom, in which an acryloyloxy group is bonded to the silicon atom via R¹. The T unit means a unit having three O_{1/2}'s for one silicon atom.

In the constitutional unit (b), R¹ is an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms. R¹ is preferably an alkylene group having from 1 to 10 carbon atoms or a cycloalkylene group having from 3 to 10 carbon atoms, and more preferably an alkylene group having from 1 to 10 carbon atoms.

The alkylene group having from 1 to 10 carbon atoms is preferably an alkylene group having from 1 to 6 carbon atoms, more preferably an alkylene group having from 2 to 4 carbon atoms, and still more preferably a propylene group. The alkylene group having from 1 to 10 carbon atoms may be linear or branched.

The cycloalkylene group having from 3 to 10 carbon atoms is preferably a cycloalkylene group having from 3 to 6 carbon atoms, and more preferably a cycloalkylene group having from 4 to 6 carbon atoms. The cycloalkylene group having from 3 to 10 carbon atoms may be branched.

The proportion of the constitutional unit (b) in the silsesquioxane derivative of the invention is not particularly limited. For example, the molar ratio (u/(t+u+v+w+x+y+z)) of the constitutional unit (b) in all constitutional units is preferably from 0.2 to 0.99, more preferably from 0.3 to 0.9, and still more preferably from 0.35 to 0.8, from the viewpoint of the ultraviolet (hereinafter, also referred to as UV) curability.

### (Constitutional Unit (c))

The constitutional unit (c) is a T unit including three O_{1/2}'s (1.5 as oxygen atoms) for one silicon atom, in which an acryloyloxy group in which a hydrogen atom is substituted with R³ is bonded to the silicon atom via R².

In the constitutional unit (c), R² is an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms. A preferred aspect of R² is the same as R¹ in the constitutional unit (b).

In the constitutional unit (c), R³ is an alkyl group having from 1 to 6 carbon atoms. Examples of the alkyl group having from 1 to 6 carbon atoms include a methyl group, an ethyl group, a propyl group, a butyl group, a pentyl group, and a hexyl group, a methyl group or an ethyl group is preferable, and a methyl group is more preferable.

The proportion of the constitutional unit (c) in the silsesquioxane derivative of the invention is not particularly limited. For example, the molar ratio (v/(t+u+v+w+x+y+z)) of the constitutional unit (c) in all constitutional units is preferably from 0 to 0.7, more preferably from 0.05 to 0.6, and still more preferably from 0.1 to 0.5, from the viewpoint of the hardness and UV curability as a cured product.

The molar ratio of the constitutional unit (c) in all constitutional units may be 0.

In Formula (1), at least one of u or v is a positive number, and from the viewpoint of the hardness as a cured product, each of u and v is independently preferably a positive number.

The total molar ratio ((u+v)/(t+u+v+w+x+y+z)) of the constitutional unit (b) and the constitutional unit (c) in all constitutional units is preferably from 0.3 to 0.99, more preferably from 0.5 to 0.98, and still more preferably from 0.7 to 0.95, from the viewpoint of the hardness as a cured product and the viscosity.

The molar ratio (v/u+v) of the constitutional unit (c) with respect to the sum of the constitutional unit (b) and the constitutional unit (c) is preferably from 0 to 0.7, more preferably from 0.05 to 0.6, and still more preferably from 0.1 to 0.5, from the viewpoint of the hardness as a cured product and the viscosity.

### (Constitutional Unit (d))

The constitutional unit (d) is a T unit including three O_{1/2}'s (1.5 as oxygen atoms) for one silicon atom, in which R⁴ is bonded to the silicon atom.

In the constitutional unit (d), R⁴ is a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms.

The saturated or unsaturated alkyl group having from 1 to 20 carbon atoms may be linear or branched. The saturated or unsaturated alkyl group having from 1 to 20 carbon atoms is preferably a saturated or unsaturated alkyl group having from 1 to 10 carbon atoms, and more preferably a saturated alkyl group having from 1 to 10 carbon atoms.

Examples of the saturated alkyl group having from 1 to 10 carbon atoms include a methyl group, an ethyl group, a propyl group, a butyl group, a pentyl group, a hexyl group, a heptyl group, an octyl group, a nonyl group, and a decyl group. From the viewpoint of the heat resistance and the hardness of a cured product, a methyl group or an ethyl group is preferable, and a methyl group is more preferable.

Examples of the unsaturated alkyl group having from 1 to 10 carbon atoms include a vinyl group, a 2-propenyl group, and an ethynyl group.

The saturated or unsaturated cycloalkyl group having from 3 to 8 carbon atoms may be branched. The saturated or unsaturated cycloalkyl group having from 3 to 8 carbon atoms is preferably a saturated or unsaturated cycloalkyl group having from 4 to 6 carbon atoms.

The aryl group having from 6 to 20 carbon atoms is preferably an aryl group having from 6 to 10 carbon atoms.

Examples of the aryl group having from 6 to 20 carbon atoms include a phenyl group, a group in which one or more hydrogen atoms of a phenyl group is substituted with an alkyl group having from 1 to 10 carbon atoms, and a naphthyl group. From the viewpoint of the heat resistance and the hardness of a cured product, a phenyl group is preferable.

The aralkyl group having from 7 to 20 carbon atoms is preferably an aralkyl group having from 7 to 10 carbon atoms.

Examples of the aralkyl group having from 7 to 20 carbon atoms include a group in which one hydrogen atom of an alkyl group having from 1 to 10 carbon atoms is substituted with an aryl group such as a phenyl group. Examples thereof include a benzyl group and a phenethyl group, and from the viewpoint of the heat resistance and the hardness of a cured product, a benzyl group is preferable.

In a case in which a part of the structure represented by R⁴ is substituted with a substituent or a halogen atom, examples of R⁴ include a 3-glycidoxypropyl group, a 2-(3,4-epoxycyclohexyl)ethyl group, a 3-(3-ethyloxetane-3-yl)methoxypropyl group, a 3-hydroxypropyl group, a 3-aminopropyl group, a 3-dimethylaminopropyl group, a 3-hydroxypropyl group, a hydrochloride of a 3-aminopropyl group, a hydrochloride of a 3-dimethylaminopropyl group, a p-styryl group, a N-2-(aminoethyl)-3-aminopropyl group, a N-phenyl-3-aminopropyl group, a hydrochloride of a N-(vinylbenzyl)-2-aminoethyl-3-aminopropyl group, a 3-ureidopropyl group, a 3-mercaptopropyl group, a 3-isocyanatopropyl group, a 3-carboxypropyl group, and a 3-chloropropyl group.

The proportion of the constitutional unit (d) in the silsesquioxane derivative of the invention is not particularly limited. For example, the molar ratio (w/(t+u+v+w+x+y+z)) of the constitutional unit (d) in all constitutional units is preferably 0.1 or less, more preferably 0.05 or less, and still more preferably 0, from the viewpoint of the hardness as a cured product.

### (Constitutional Unit (e))

The constitutional unit (e) is a D unit including two O_{1/2}'s (1 as oxygen atoms) for one silicon atom, in which two R⁵'s are bonded to the silicon atom. The D unit means a unit having two O_{1/2}'s for one silicon atom.

In the constitutional unit (e), R⁵ is a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms. In the constitutional unit (d), a plurality of R⁵'s present may be the same as or different from each other. A preferred aspect of R⁵ is the same as R⁴ in the constitutional unit (d).

The proportion of the constitutional unit (e) in the silsesquioxane derivative of the invention is not particularly limited. For example, the molar ratio (x/(t+u+v+w+x+y+z)) of the constitutional unit (e) in all constitutional units is preferably 0.1 or less, more preferably 0.05 or less, and still more preferably 0, from the viewpoint of the hardness as a cured product.

### (Constitutional Unit (f))

The constitutional unit (f) is an M unit including one O_{1/2} (0.5 as oxygen atoms) for one silicon atom, in which one R⁶ and two R⁵'s are bonded to the silicon atom. The M unit means a unit having one O_{1/2} for one silicon atom.

In the constitutional unit (f), R⁶ is an organic group having from 2 to 12 carbon atoms and having at least one of an ethylenically unsaturated bond or a carbon-carbon triple bond.

Examples of the organic group having from 2 to 12 carbon atoms and having an ethylenically unsaturated bond include a vinyl group, an orthostyryl group, a methstyryl group, a parastyryl group, an acryloyloxymethyl group, a methacryloyloxymethyl group, a 2-acryloyloxyethyl group, a 2-methacryloyloxyethyl group, a 3-acryloyloxypropyl group, a 3-methacryloyloxypropyl group, a 8-acryloyloxyoctyl group, a 8-methacryloyloxyoctyl group, a 1-propenyl group, a 2-propenyl group, a 1-methylethenyl group, a 1-butenyl group, a 3-butenyl group, a 1-pentenyl group, a 4-pentenyl group, a 3-methyl-1-butenyl group, a 1-phenylethenyl group, a 2-phenylethenyl group, an ethynyl group, a 1-propynyl group, a 2-propynyl group, a 1-butynyl group, a 3-butynyl group, a 1-pentynyl group, a 4-pentynyl group, a 3-methyl-1-butynyl group, and a phenylbutynyl group. From the viewpoint of the hardness as a cured product, a vinyl group, a 2-propenyl group, an orthostyryl group, a methastyryl group, or a parastyryl group is preferable, and a vinyl group is more preferable.

In the constitutional unit (f), R⁷ is an alkyl group having from 1 to 10 carbon atoms, an aryl group having from 6 to 10 carbon atoms, or an aralkyl group having from 7 to 10 carbon atoms. In the constitutional unit (f), a plurality of R⁷'s present may be the same as or different from each other.

Examples of the alkyl group having from 1 to 10 carbon atoms include a methyl group, an ethyl group, a propyl group, a butyl group, a pentyl group, a hexyl group, a heptyl group, an octyl group, a nonyl group, and a decyl group. From the viewpoint of the heat resistance and the hardness of a cured product, a methyl group or an ethyl group is preferable, and a methyl group is more preferable.

Examples of the aryl group having from 6 to 10 carbon atoms include a phenyl group, a group in which one or more hydrogen atoms of a phenyl group is substituted with an alkyl group having from 1 to 4 carbon atoms, and a naphthyl group. From the viewpoint of the heat resistance and the hardness of a cured product, a phenyl group is preferable.

Examples of the aralkyl group having from 7 to 10 carbon atoms include a group in which one hydrogen atom of an alkyl group having from 1 to 4 carbon atoms is substituted with an aryl group such as a phenyl group. Examples thereof include a benzyl group and a phenethyl group, and from the viewpoint of the heat resistance and the hardness of a cured product, a benzyl group is preferable.

The proportion of the constitutional unit (f) in the silsesquioxane derivative of the invention is not particularly limited. For example, the molar ratio (y/(t+u+v+w+x+y+z)) of the constitutional unit (f) in all constitutional units is preferably from 0.01 to 0.5, more preferably from 0.02 to 0.4, and still more preferably from 0.05 to 0.35, from the viewpoint of the hardness as a cured product and the viscosity.

The molar ratio of the constitutional units (b) and (c) and the constitutional unit (f) (the constitutional units (b) and (c): the constitutional unit (f)) is preferably from 50:50 to 99:1, more preferably from 60:40 to 98:2, and still more preferably from 65:35 to 95:5, from the viewpoint of the hardness as a cured product and the viscosity.

### (Constitutional Unit (g))

The constitutional unit (g) is an M unit including one O_{1/2} (0.5 as oxygen atoms) for one silicon atom, in which three R⁸'s are bonded to the silicon atom.

In the constitutional unit (g), R⁸ is an alkyl group having from 1 to 10 carbon atoms, an aryl group having from 6 to 10 carbon atoms, or an aralkyl group having from 7 to 10 carbon atoms. In the constitutional unit (g), a plurality of R⁸'s present may be the same as or different from each other. A preferred aspect of R⁸ is the same as R⁷ in the constitutional unit (f).

The proportion of the constitutional unit (g) in the silsesquioxane derivative of the invention is not particularly limited. For example, the molar ratio (z/(t+u+v+w+x+y+z)) of the constitutional unit (g) in all constitutional units is preferably 0.1 or less, more preferably 0.05 or less, and still more preferably 0, from the viewpoint of the hardness as a cured product.

### (Other Constitutional Unit (h))

The silsesquioxane derivative of the invention may further include (R⁹O_{1/2}) as a constitutional unit not containing Si (hereinafter, also referred to as the constitutional unit (h)).

R⁹ is a hydrogen atom or an alkyl group having from 1 to 6 carbon atoms. The alkyl group having from 1 to 6 carbon atoms may be either an aliphatic group or an alicyclic group, or may be either linear or branched. Specific examples of the alkyl group having from 1 to 6 carbon atoms include a methyl group, an ethyl group, a propyl group, a butyl group, a pentyl group, and a hexyl group.

The constitutional unit (h) is an alkoxy group which is a hydrolyzable group contained in a silicon compound described below, or an alkoxy group produced by substituting an alcohol contained in a reaction solvent with a hydrolyzable group of a silicon compound, and may remain in the molecule without hydrolysis or polycondensation, or may be a hydroxyl group remaining in the molecule without polycondensation after hydrolysis.

In Formula (1), it is preferable that t, x, and z are 0 and w is 0 or a positive number, and t, w, x, and z are more preferably 0. In Formula (1), 0.01≤y/(u+v+w)≤0.5 is preferable, 0.02≤y/(u+v+w)≤0.4 is more preferable, and 0.05≤y/(u+v+w)≤0.35 is still more preferable.

In Formula (1), each of u and v is independently a positive number, 0≤v/u≤1 is preferable, 0.1≤v/u≤1 is more preferable, 0.2≤v/u≤1 is still more preferable, and 0.3≤v/u≤1 is particularly preferable.

### (Weight Average Molecular Weight of Silsesquioxane Derivative)

The weight average molecular weight (hereinafter, also referred to as “Mw”) of the silsesquioxane derivative of the invention is not particularly limited, and for example, may be from 300 to 30,000, from 500 to 15,000, from 700 to 10,000, or from 1,000 to 5,000.

Mw in the invention means a value obtained by converting a molecular weight measured by gel permeation chromatography (GPC) using polystyrene as a standard substance. As measurement conditions of Mw, for example, measurement conditions in Examples described below can be used.

### (Viscosity of Silsesquioxane Derivative)

The viscosity at 25° C. of the silsesquioxane derivative of the invention is preferably from 10 mPa s to 4,000 mPa s, more preferably from 50 mPa s to 2,000 mPa s, and still more preferably from 100 mPa s to 1,600 mPa s.

In the invention, the viscosity at 25° C. means a value measured using an E-type viscometer (cone/plate type viscometer; for example, TVE22H type viscometer manufactured by Toki Sangyo Co., Ltd.).

### (Method of Producing Silsesquioxane Derivative)

The silsesquioxane derivative of the invention can be produced by a known method. The method of producing a silsesquioxane derivative is disclosed in detail as a method of producing a polysiloxane in WO 2013/031798 A.

The silsesquioxane derivative of the invention can be produced, for example, by the following method.

A method of producing a silsesquioxane derivative of the invention includes a condensation step of performing hydrolysis and a polycondensation reaction of a silicon compound providing a constitutional unit in the above Formula (1) by condensation in an appropriate reaction solvent. In the condensation step, for example, at least a silicon compound (hereinafter, also referred to as “silicon compound 3”) forming the constitutional unit (f) (M unit) having one siloxane bond-forming group and one of a silicon compound (hereinafter, also referred to as “silicon compound 1”) forming the constitutional unit (b) (T unit) having three siloxane bond-forming groups or a silicon compound (hereinafter, also referred to as “silicon compound 2”) forming the constitutional unit (c) (T unit) having three siloxane bond-forming groups are used. If necessary, other silicon compounds (hereinafter, also referred to as “silicon compound 4”, “silicon compound 5”, “silicon compound 6”, or “silicon compound 7”, respectively) forming the constitutional unit (a), the constitutional unit (d), the constitutional unit (e), or the constitutional unit (g) may be used.

In the condensation step, the hydrolysis and the polycondensation reaction of the silicon compounds 1 to 3 and, if necessary, other silicon compounds may be performed. Alternatively, some of the silicon compounds 1 to 3 and, if necessary, other silicon compounds may be subjected to hydrolysis and a polycondensation reaction to obtain a silsesquioxane derivative as an intermediate product, and then the obtained intermediate product and the rest of the silicon compounds 1 to 3, and the like may be further subjected to hydrolysis and a polycondensation reaction.

In the case of obtaining an intermediate product as described above, the silicon compound 1 and the silicon compound 2, and if necessary, the other silicon compounds may be subjected to hydrolysis and a polycondensation reaction, and then the obtained intermediate product and the silicon compound 3 may be further subjected to hydrolysis and a polycondensation reaction. As a result, a silsesquioxane derivative in which the terminal portion is sealed with the constitutional unit (f) derived from the silicon compound 3 can be suitably synthesized, an increase in viscosity of the silsesquioxane derivative is suppressed, and storage stability becomes favorable.

The method of producing a silsesquioxane derivative of the invention preferably includes a distillation step of subjecting a silicon compound to hydrolysis and a polycondensation reaction in the presence of a reaction solvent, and then distilling off the reaction solvent, by-products, residual monomers, water, and the like in a reaction solution.

Examples of the silicon compound 1 include (3-acryloyloxypropyl)trimethoxysilane, (3-acryloyloxypropyl)triethoxysilane, (8-acryloyloxyoctyl)trimethoxysilane, and (3-acryloyloxypropyl)trichlorosilane.

Examples of the silicon compound 2 include (3-methacryloyloxypropyl)trimethoxysilane, (3-methacryloyloxypropyl)triethoxysilane, (8-methacryloyloxyoctyl)trimethoxysilane, and (3-methacryloyloxypropyl)trichlorosilane.

Examples of the silicon compound 3 include 1,3-divinyltetramethyldisiloxane, 1,3-bis(p-styryl)tetramethyldisiloxane, 1,3-bis(3-acryloyloxypropyl)tetramethyldisiloxane, and 1,3-bis(3-methacryloyloxypropyl)tetramethyldisiloxane, which provides two constitutional units (f) by hydrolysis, as well as methoxydimethylvinylsilane, ethoxydimethylvinylsilane, chlorodimethylvinylsilane, dimethylvinylsilanol, (3-acryloyloxypropyl)dimethylmethoxysilane, (3-methacryloyloxypropyl)dimethylmethoxysilane, p-styryldimethylmethoxysilane, and ethynyldimethylmethoxysilane.

Examples of the silicon compound 4 include tetramethoxysilane and tetraethoxysilane.

Examples of the silicon compound 5 include methyltrimethoxysilane, methyltriethoxysilane, ethyltrimethoxysilane, propyltrimethoxysilane, octyltrimethoxysilane, phenyltrimethoxysilane, phenyltriethoxysilane, benzyltrimethoxysilane, cyclohexyltrimethoxysilane, vinyltrimethoxysilane, allyltrimethoxysilane, p-styryltrimethoxysilane, ethynyltrimethoxysilane, 2-(3,4-epoxycyclohexyl)ethyltrimethoxysilane, 3-glycidoxypropyltrimethoxysilane, N-2-(aminoethyl)-3-aminopropyltrimethoxysilane, 3-aminopropyltrimethoxysilane, 3-triethoxysilyl-N-(1,3-dimethyl-butylidene)propylamine, N-phenyl-3-aminopropyltrimethoxysilane, a hydrochloride of N-(vinylbenzyl)-2-aminoethyl-3-aminopropyltrimethoxysilane, 3-ureidopropyltrialkoxysilane, 3-isocyanatopropyltriethoxysilane, tris-(trimethoxysilylpropyl)isocyanurate, 3-mercaptopropyltrimethoxysilane, 3-ethyl-3-[{3-(trimethoxysilyl)propoxy}methyl]oxetane, and 3-ethyl-3-[{3-(triethoxysilyl)propoxy}methyl]oxetane.

Examples of the silicon compound 6 include dimethyldimethoxysilane, dimethyldiethoxysilane, diethyldiethoxysilane, propylmethyldimethoxysilane, octylmethyldimethoxysilane, phenylmethyldimethoxysilane, diphenyldiethoxysilane, benzylmethyldimethoxysilane, cyclohexylmethyldimethoxysilane, vinylmethyldimethoxysilane, allylmethyldimethoxysilane, p-styrylmethyldimethoxysilane, ethynylmethyldimethoxysilane, 2-(3,4-epoxycyclohexyl)ethylmethyldimethoxysilane, 3-glycidoxypropylmethyldimethoxysilane, N-2-(aminoethyl)-3-aminopropylmethyldimethoxysilane, 3-aminopropylmethyldimethoxysilane, N-phenyl-3-aminopropylmethyldimethoxysilane, a hydrochloride of N-(vinylbenzyl)-2-aminoethyl-3-aminopropylmethyldimethoxysilane, 3-ureidopropylmethyldialkoxysilane, 3-isocyanatopropylmethyldiethoxysilane, (3-acryloxypropyl)methyldimethoxysilane, and (3-methacryloxypropyl)methyldiethoxysilane.

Examples of the silicon compound 7 include hexamethyldisiloxane, trimethylmethoxysilane, trimethylethoxysilane, trimethylchlorosilane, and dimethylphenylmethoxysilane.

In the condensation step, an alcohol may be used as the reaction solvent. The alcohol is a narrow-sense alcohol represented by general formula R—OH, and is a compound having no functional group other than an alcoholic hydroxyl group.

The alcohol is not particularly limited, and examples thereof include methanol, ethanol, 1-propanol, 2-propanol, 2-butanol, 2-pentanol, 3-pentanol, 2-methyl-2-butanol, 3-methyl-2-butanol, cyclopentanol, 2-hexanol, 3-hexanol, 2-methyl-2-pentanol, 3-methyl-2-pentanol, 2-methyl-3-pentanol, 3-methyl-3-pentanol, 2-ethyl-2-butanol, 2,3-dimethyl-2-butanol, and cyclohexanol. Among them, secondary alcohols such as 2-propanol, 2-butanol, 2-pentanol, 3-pentanol, 3-methyl-2-butanol, cyclopentanol, 2-hexanol, 3-hexanol, 3-methyl-2-pentanol, and cyclohexanol are preferable.

In the condensation step, these alcohols may be used singly or in combination of two or more kinds thereof.

The reaction solvent used in the condensation step may be only an alcohol, or may be a mixed solvent with at least one sub solvent. The sub solvent may be either a polar solvent or a non-polar solvent, or may be a combination of both.

The hydrolysis and the polycondensation reaction in the condensation step proceed in the presence of water.

The amount of water used for hydrolyzing the hydrolyzable group contained in the silicon compound is preferably from 0.5 to 5 times by mole and more preferably from 1 to 2 times by mole with respect to the amount (mol) of the substance of the hydrolyzable group.

The hydrolysis and the polycondensation reaction of the silicon compound may be performed in the absence of a catalyst or may be performed using a catalyst. In the case of using a catalyst, acid catalysts exemplified as inorganic acids such as sulfuric acid, nitric acid, hydrochloric acid, and phosphoric acid; and organic acids such as formic acid, acetic acid, oxalic acid, and p-toluenesulfonic acid, base catalysts such as ammonia, tetramethylammonium hydroxide, sodium hydroxide, potassium hydroxide, sodium carbonate, and potassium carbonate, and the like are preferably used, and acid catalysts are more preferably used.

The amount of the catalyst used is preferably an amount corresponding to from 0.01 mol % to 20 mol % and more preferably an amount corresponding to from 0.1 mol % to 10 mol % with respect to the total amount (mol) of the silicon atoms contained in the silicon compound.

Completion of the hydrolysis and the polycondensation reaction in the condensation step can be detected as appropriate using methods disclosed in the various publications and the like. In the condensation step in the production of the silsesquioxane derivative of the invention, an auxiliary agent can be added to the reaction system.

By providing the distillation step after the condensation step in the production of the silsesquioxane derivative of the invention, the stability of the produced silsesquioxane derivative of the invention can be improved. The distillation can be performed under normal pressure or reduced pressure, can be performed under normal temperature or heating, or can also be performed under cooling.

The method of producing a silsesquioxane derivative can include a neutralization step of neutralizing the catalyst before the distillation step. The method can also include a step of removing the salt generated by neutralization by washing with water or the like.

The silsesquioxane derivative represented by Formula (1) may contain a ring-opened group obtained by adding an acid or the like to an oxetanyl group or an epoxy group among a side chain functional groups derived from a silicon compound used for production as a raw material, may contain a hydroxyalkyl group produced by decomposition of an organic group having a (meth)acryloyl group, or may contain a group obtained by adding an acid or the like to an unsaturated hydrocarbon group or the like. Specific examples thereof include those in which a part of Formula (1) includes a structure represented by the following Formula (A) and/or a structure represented by the following Formula (B). In a case in which the content ratio thereof is 50 mol % or less with respect to the amount corresponding to the original organic group having an oxetanyl group or epoxy group, the original organic group having a (meth)acryloyl group, or the original organic group having an unsaturated hydrocarbon group, which is derived from the silicon compound as a raw material, there is no problem in carrying out the invention, and the content ratio thereof is preferably 30 mol % or less and more preferably 10 mol % or less. In both of Formulas (A) and (B), the T unit is exemplified, but the similar D unit, M unit, or the like may be used.

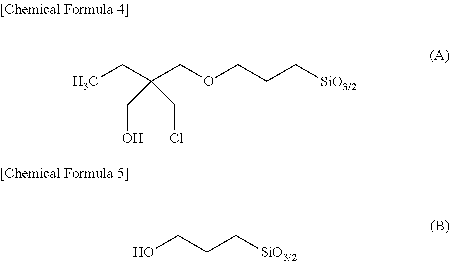

### [Curable Composition]

A curable composition of the invention contains the silsesquioxane derivative of the invention and a polymerization initiator. The curable composition of the invention may be a hard coat agent.

The curable composition of the invention may contain various components (hereinafter, also referred to as “other components”) if necessary.

### (Polymerization Initiator)

The polymerization initiator is not particularly limited, and examples thereof include a photopolymerization initiator and a thermal polymerization initiator. Examples of the photopolymerization initiator include a photoradical polymerization initiator.

Examples of the thermal polymerization initiator include a thermal radical polymerization initiator.

As the photopolymerization initiator and the thermal polymerization initiator, known compounds may be used.

Examples of the photoradical polymerization initiator include acetophenone-based compounds such as 2,2-dimethoxy-1,2-diphenylethane-1-one, 1-hydroxycyclohexyl phenyl ketone, 2-hydroxy-2-methyl-1-phenylpropane-1-one, 1-[4-(2-hydroxyethoxy)phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)-butane-1-one, diethoxyacetophenone, oligo[2-hydroxy-2-methyl-1-[4-(1-methylvinyl)phenyl]propanone], and 2-hydroxy-1-{4-[4-(2-hydroxy-2-methyl-propionyl)benzyl]phenyl}-2-methyl-propane-1-one; benzophenone-based compounds such as benzophenone, 4-phenylbenzophenone, 2,4,6-trimethylbenzophenone, and 4-benzoyl-4′-methyldiphenylsulfide; α-ketoester-based compounds such as methylbenzoylformate, oxyphenylacetic acid 2-[2-oxo-2-phenylacetoxyethoxy]ethyl ester, and oxyphenylacetic acid 2-[2-hydroxyethoxy]ethyl ester; phosphine oxide-based compounds such as 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide; benzoin-based compounds such as benzoin, benzoin methyl ether, benzoin ethyl ether, benzoin isopropyl ether, and benzoin isobutyl ether; titanocene-based compounds; acetophenone/benzophenone hybrid photoinitiators such as 1-(4-(4-benzoylphenylsulfanyl)phenyl)-2-methyl-2-(4-methylphenylsulfinyl)propane-1-one; oxime ester-based photopolymerization initiators such as 1-(4-phenylthiophenyl)-2-(O-benzoyloxime)-1,2-octanedione; and camphorquinone. These may be used singly or can also be used in combination of two or more kinds thereof.

The thermal radical polymerization initiator is not particularly limited, and examples thereof include a peroxide and an azo-based initiator.

Examples of the peroxide include hydrogen peroxide; inorganic peroxides such as sodium persulfate, ammonium persulfate, and potassium persulfate; and organic peroxides such as 1,1-bis(t-butylperoxy)2-methylcyclohexane, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclohexane, 2,2-bis(4,4-di-butylperoxycyclohexyl)propane, 1,1-bis(t-butylperoxy)cyclododecane, t-hexylperoxyisopropyl monocarbonate, t-butylperoxymaleic acid, t-butylperoxy-3,5,5-trimethylhexanoate, t-butylperoxylaurate, 2,5-dimethyl-2,5-di(m-toluoylperoxy)hexane, t-butylperoxyisopropyl monocarbonate, t-butylperoxy2-ethylhexyl monocarbonate, t-hexylperoxybenzoate, 2,5-dimethyl-2,5-di(benzoylperoxy)hexane, t-butylperoxyacetate, 2,2-bis(t-butylperoxy)butane, t-butylperoxybenzoate, n-butyl-4,4-bis(t-butylperoxy)valerate, di-t-butylperoxyisophthalate, α,α′-bis(t-butylperoxy)diisopropylbenzene, dicumyl peroxide, 2,5-dimethyl-2,5-di(t-butylperoxy)hexane, t-butylcumyl peroxide, di-t-butylperoxide, p-menthane hydroperoxide, 2,5-dimethyl-2,5-di(t-butylperoxy)hexyne-3, diisopropylbenzene hydroperoxide, t-butyltrimethylsilyl peroxide, 1,1,3,3-tetramethylbutyl hydroperoxide, cumene hydroperoxide, t-hexyl hydroperoxide, and t-butyl hydroperoxide.

These may be used singly or can also be used in combination of two or more kinds thereof.

Examples of the azo-based initiator include azo compounds such as 2,2′-azobisisobutyronitrile, 1,1′-azobis(cyclohexane-1-carbonitrile), 2-(carbamoylazo)isobutyronitrile, 2-phenylazo-4-methoxy-2,4-dimethylvaleronitrile, azodi-t-octane, and azodi-t-butane, and these may be used singly or can also be used in combination of two or more kinds thereof.

A redox reaction can also be carried out by combining with a redox polymerization initiation system using a peroxide in combination with a reducing agent such as ascorbic acid, sodium ascorbate, sodium erythorbate, tartaric acid, citric acid, a metal salt of formaldehyde sulfoxylate, sodium thiosulfate, sodium sulfite, sodium bisulfite, sodium metabisulfite, or ferric chloride.

The content of the polymerization initiator in the curable composition of the invention is preferably from 0.01 parts by mass to 20 parts by mass, more preferably from 0.1 parts by mass to 10 parts by mass, and still more preferably from 1 part by mass to 5 parts by mass, with respect to 100 parts by mass of the silsesquioxane derivative represented by Formula (1).

### (Other Components)

The other components are not particularly limited, and examples thereof include a solvent, a polymerizable compound other than the silsesquioxane derivative represented by Formula (1), a resin, silicone, a monomer, a filler, a surfactant, an antistatic agent (for example, a conductive polymer), a leveling agent, a photosensitizer, an ultraviolet absorber, an antioxidant, a heat resistance improver, a stabilizer, a lubricant, a pigment, a dye, a plasticizer, a suspending agent, an adhesion imparting agent, nanoparticles, nanofibers, and a nanosheet. The curable composition of the invention may contain silane-based reactive diluents such as tetraalkoxysilanes, trialkoxysilanes, dialkoxysilanes, monoalkoxysilanes, and disiloxanes.

The curable composition of the invention may contain a solvent, or does not necessarily contain a solvent.

Examples of the solvent include various organic solvents such as an aliphatic hydrocarbon solvent, an aromatic hydrocarbon solvent, a chlorinated hydrocarbon solvent, an alcohol solvent, an ether solvent, an amide solvent, a ketone solvent, an ester solvent, and a cellosolve solvent.

The curable composition of the invention may contain or does not necessarily contain a polymerizable compound (hereinafter, also referred to as “other polymerizable compound”) other than the silsesquioxane derivative represented by Formula (1).

The other polymerizable compound is not particularly limited as long as it is a compound that can undergo a polymerization reaction in the presence of the silsesquioxane derivative represented by Formula (1) and the polymerization initiator. Examples of the other polymerizable compound include a silsesquioxane derivative other than the silsesquioxane derivative represented by Formula (1), a (meth)acrylate compound, a compound having an ethylenically unsaturated group, an epoxy compound (a compound having an epoxy group), a compound having an oxetanyl group (oxetanyl group-containing compound), and a compound having a vinyl ether group (vinyl ether compound).

Examples of the silsesquioxane derivative other than the silsesquioxane derivative represented by Formula (1) include a silsesquioxane derivative composed only of a T unit, and a silsesquioxane derivative including a T unit and a D unit.

The (meth)acrylate compound is not particularly limited, and examples thereof include a compound having one (meth)acryloyl group (hereinafter, also referred to as “monofunctional (meth)acrylate”), and a compound having two or more (meth)acryloyl groups (hereinafter, also referred to as “polyfunctional (meth)acrylate”).

Examples of the monofunctional (meth)acrylate include:
alkyl (meth)acrylates such as methyl (meth)acrylate, ethyl (meth)acrylate, butyl (meth)acrylate, and 2-ethylhexyl (meth)acrylate;
monofunctional (meth)acrylates having an alicyclic group such as cyclohexyl (meth)acrylate, tert-butylcyclohexyl (meth)acrylate, isobornyl (meth)acrylate, and tricyclodecamethylol (meth)acrylate;
monofunctional (meth)acrylates having an aromatic group such as benzyl (meth)acrylate and phenyl (meth)acrylate;
(meth)acrylates of alkylene oxide adducts of phenol derivatives such as (meth)acrylate of a phenol ethylene oxide adduct, (meth)acrylate of a phenol propylene oxide adduct, (meth)acrylate of a modified nonylphenol ethylene oxide adduct, (meth)acrylate of a nonylphenol propylene oxide adduct, (meth)acrylate of an alkylene oxide adduct of paracumyl phenol, orthophenylphenol (meth)acrylate, and (meth)acrylate of an alkylene oxide adduct of orthophenylphenol;
monofunctional (meth)acrylates having an alkoxyalkyl group such as 2-ethylhexyl carbitol (meth)acrylate;
monofunctional (meth)acrylates having a heterocyclic ring such as tetrahydrofurfuryl (meth)acrylate and N-(2-(meth)acryloxyethyl)hexahydrophthalimide;
hydroxylalkyl (meth)acrylates such as hydroxyethyl (meth)acrylate, hydroxypropyl (meth)acrylate, hydroxybutyl (meth)acrylate, and hydroxyhexyl (meth)acrylate;
monofunctional (meth)acrylates having a hydroxyl group and an aromatic group such as 2-hydroxy-3-phenoxypropyl (meth)acrylate;
alkylene glycol mono(meth)acrylates such as diethylene glycol mono(meth)acrylate, dipropylene glycol mono(meth)acrylate, triethylene glycol mono(meth)acrylate, and tripropylene glycol mono(meth)acrylate; and
monofunctional (meth)acrylates having a carboxy group such as o-carboxypolycaprolactone mono(meth)acrylate and monohydroxyethyl phthalate (meth)acrylate.

Examples of the polyfunctional (meth)acrylate include:
polyethylene glycol di(meth)acrylates such as diethylene glycol di(meth)acrylate, triethylene glycol di(meth)acrylate, and tetraethylene glycol di(meth)acrylate;
polypropylene glycol di(meth)acrylates such as dipropylene glycol di(meth)acrylate, tripropylene glycol di(meth)acrylate, and tetrapropylene glycol di(meth)acrylate; and
1,4-butanediol di(meth)acrylate, neopentyl glycol di(meth)acrylate, di(meth)acrylate of ethylene oxide-modified neopentyl glycol, di(meth)acrylate of ethylene oxide-modified bisphenol A, di(meth)acrylate of propylene oxide-modified bisphenol A, di(meth)acrylate of ethylene oxide-modified hydrogenated bisphenol A, trimethylolpropane di(meth)acrylate, trimethylolpropane allyl ether di(meth)acrylate, trimethylolpropane tri(meth)acrylate, ethylene oxide-modified trimethylolpropane tri(meth)acrylate, propylene oxide-modified trimethylolpropane tri(meth)acrylate, pentaerythritol tri(meth)acrylate, pentaerythritol tetra(meth)acrylate, and dipentaerythritol hexaacrylate.

As the polyfunctional (meth)acrylate, urethane (meth)acrylate can also be used. Examples of the urethane (meth)acrylate include a compound obtained by addition reaction of an organic polyisocyanate and a hydroxyl group-containing (meth)acrylate, and a compound obtained by addition reaction of an organic polyisocyanate, a polyol, and a hydroxyl group-containing (meth)acrylate.

The monofunctional (meth)acrylate, the polyfunctional (meth)acrylate, and the like may be used singly or can also be used in combination of two or more kinds thereof, and different types thereof can be used in combination.

Examples of the polyol include low-molecular-weight polyols, polyether polyols, polyester polyols, and polycarbonate polyols.

Examples of the low-molecular-weight polyols include ethylene glycol, propylene glycol, neopentyl glycol, cyclohexane dimethylol, and 3-methyl-1,5-pentanediol.

Examples of the polyether polyols include polypropylene glycol and polytetramethylene glycol.

Examples of the polyester polyol include reaction products of these low-molecular-weight polyols and/or polyether polyols with acid components such as dibasic acids such as adipic acid, succinic acid, phthalic acid, hexahydrophthalic acid, and terephthalic acid or anhydrides thereof.

These may be used singly or can also be used in combination of two or more kinds thereof, and different types thereof can be used in combination.

Examples of the organic polyisocyanate include tolylene diisocyanate, xylylene diisocyanate, tetramethylxylylene diisocyanate, 4,4′-diphenylmethane diisocyanate, 4,4′-dicyclohexylmethane diisocyanate, hexamethylene diisocyanate, and isophorone diisocyanate.

Examples of the hydroxyl group-containing (meth)acrylate include hydroxyalkyl (meth)acrylates such as 2-hydroxyethyl (meth)acrylate, 2-hydroxypropyl (meth)acrylate, and 4-hydroxybutyl (meth)acrylate; and hydroxyl group-containing polyfunctional (meth)acrylates such as pentaerythritol tri(meth)acrylate, di(meth)acrylate of alkylene oxide 3-mol adduct of isocyanuric acid, and dipentaerythritol penta(meth)acrylate.

These may be used singly or can also be used in combination of two or more kinds thereof, and different types thereof can be used in combination.

In a case in which a (meth)acrylate compound is used in combination in the curable composition of the invention, the formulation ratio thereof is not particularly limited, and for example, the formulation ratio of the (meth)acrylate compound with respect to 100 parts by mass of the silsesquioxane derivative represented by the above Formula (1) is preferably from 0 parts by mass to 100 parts by mass, more preferably from 0 parts by mass to 50 parts by mass, and still more preferably from 0 parts by mass to 20 parts by mass. From the viewpoint of adhesiveness to an inorganic material layer, the formulation ratio of the (meth)acrylate compound is preferably low, it is preferable that the (meth)acrylate compound is not contained or the content thereof is 10% by mass or less with respect to the total amount of the composition, it is more preferable that the (meth)acrylate compound is not contained or the content thereof is 5% by mass or less with respect to the total mass of the composition, it is still more preferable that the (meth)acrylate compound is not contained or the content thereof is 1% by mass or less with respect to the total mass of the composition, or it is particularly preferable that the (meth)acrylate compound is not contained.

A compound having one ethylenically unsaturated group in one molecule other than the (meth)acrylate compound may be added to the curable composition.

The ethylenically unsaturated group is preferably a (meth)acryloyl group, a maleimide group, a (meth)acrylamide group, or a vinyl group.

Specific examples of the compound having an ethylenically unsaturated group include (meth)acrylic acid, a michael addition type dimer of acrylic acid, N-(2-hydroxyethyl)citraconimide, N,N-dimethylacrylamide, acryloylmorpholine, N-vinylpyrrolidone, and N-vinylcaprolactam.

These may be used singly or can also be used in combination of two or more kinds thereof.

Examples of the epoxy compound include a monofunctional epoxy compound and a polyfunctional epoxy compound.

Examples of the oxetanyl group-containing compound include a monofunctional oxetane compound and a polyfunctional oxetane compound.

Examples of the vinyl ether compound include a monofunctional vinyl ether compound and a polyfunctional vinyl ether compound.

As these compounds, for example, compounds described in JP-A No. 2011-42755 may be used.

The silicone is not particularly limited, and a known silicone can be used, examples thereof include polydimethylsilicone, polydiphenylsilicone, and polymethylphenylsilicone, and those having a functional group at the terminal and/or side chain thereof are preferable. The functional group is not particularly limited, and examples thereof include a (meth)acryloyl group, an epoxy group, an oxetanyl group, a vinyl group, a hydroxyl group, a carboxy group, an amino group, and a thiol group.

In a case in which the curable composition of the invention contains the other polymerizable compound, the content of the other polymerizable compound is preferably from 0.01 parts by mass to 100 parts by mass, more preferably from 0.1 parts by mass to 50 parts by mass, and still more preferably from 1 part by mass to 25 parts by mass, with respect to 100 parts by mass of the silsesquioxane derivative represented by Formula (1).

### [Cured Product]

A cured product of the invention is obtained by curing the curable composition of the invention. For example, the cured product of the invention can be obtained by irradiating the curable composition of the invention with an active energy ray or heating the curable composition of the invention.

In the case of curing the curable composition of the invention, the curing may be performed after the curable composition is applied to a base material.

The curable composition of the invention may contain or does not necessarily contain a solvent. In the case of containing a solvent, the curable composition is preferably cured after the solvent is removed.

In the case of applying the curable composition of the invention to abase material, the method of applying the curable composition is not particularly limited. Examples of the application method include ordinary application methods such as a casting method, a spin coating method, a bar coating method, a dip coating method, a spray coating method, a roll coating method, a flow coating method, and a gravure coating method.

The thickness to which the curable composition of the invention is applied is not particularly limited, and is appropriately set according to the purpose.

The base material to which the curable composition of the invention is applied is not particularly limited, and examples thereof include wood, a metal, an inorganic material, plastic, paper, fibers, and a fabric.

Examples of the metal include copper, silver, iron, aluminum, silicon, silicon steel, and stainless steel. Examples of the inorganic material include metal oxides such as aluminum oxide, silicon oxide, magnesium oxide, zirconium oxide, zinc oxide, indium tin oxide, and gallium oxide, metal nitrides such as aluminum nitride, gallium nitride, and silicon nitride, ceramics such as silicon carbide and boron nitride, mortar, concrete, and glass.

Specific examples of the plastic include acrylic resins such as polymethyl methacrylate, polyester resins such as polyethylene terephthalate, polyvinyl chloride resins, polycarbonate resins, epoxy resins, polyamide resins such as nylon and aramid, polyimide resins, polyamideimide resins, fluororesins such as a tetrafluoroethylene resin, polyolefin resins such as a crosslinked polyethylene resin, vinylidene chloride resins, acrylonitrile-butadiene-styrene (ABS) resins, polystyrene resins, polyacrylonitrile resins, cycloolefin polymer (COP), cycloolefin copolymer (COC), acetate-based resins, polyarylate, cellophane, norbornene-based resins, acetylcellulose resins such as triacetylcellulose (TAC), polychloroprene, polyphenylene sulfide, polysulfone, polyether sulfone, polyether ether ketone, polyurethane resins, and composite resins such as glass epoxy resins, and various fiber reinforced resins.

Examples of the fibers include natural fibers, regenerated fibers, semi-synthetic fibers, metal fibers, glass fibers, carbon fibers, ceramic fibers, and known chemical fibers. The fabric may be a woven fabric or a nonwoven fabric, and can be produced using, for example, the above-mentioned fibers.

These materials may be used singly or in combination, mixture, or composite of two or more kinds thereof.

The shape of the base material is not particularly limited, and examples thereof include a plate shape, a sheet shape, a film shape, a rod shape, a spherical shape, a fibrous shape, a powdery shape, a lens shape, and other regular or irregular shapes.

### (Curing Method)

In the invention, the curing method and curing conditions are selected depending on whether the curable composition is active energy ray curable and/or thermosetting. The curing conditions (in the case of an active energy ray curable composition, for example, the type of light source, the amount of light irradiation, and the like, in the case of a thermosetting composition, heating temperature, heating time, and the like) are selected, if appropriate, depending on the type and amount of the polymerization initiator and the type and the like of the other polymerizable compound contained in the present composition.

### (1) Active Energy Ray Curing Method

In a case in which the present composition is an active energy ray curable composition, as a curing method thereof, active energy ray irradiation may be performed with a known active energy ray irradiation device or the like. Examples of the active energy rays include electron beams and light such as ultraviolet rays, visible rays, and X-rays, light is preferable, and from the viewpoint that an inexpensive device can be used, ultraviolet rays are more preferable.

Examples of ultraviolet irradiation devices include low-pressure mercury lamps, medium-pressure mercury lamps, high-pressure mercury lamps, ultra-high-pressure mercury lamps, metal halide lamps, ultraviolet (UV) electrodeless lamps, chemical lamps, black light lamps, microwave-excited mercury lamps, and light-emitting diodes (LEDs).

The intensity of light irradiation to the coating film applied with the present composition may be selected according to the purpose, use application, and the like, and the intensity of light irradiation in a light wavelength range (depending on the type of photopolymerization initiator, light with a wavelength of from 220 nm to 460 nm is preferably used) effective for activation of an active energy ray polymerization initiator (in the case of photocuring, the initiator is referred to as a photopolymerization initiator) is preferably from 0.1 mW/cm² to 1000 mW/cm².

The irradiation energy should be set, if appropriate, according to the type of the active energy ray, the formulation composition, and the like. The light irradiation time to the coating film may also be selected according to the purpose, use application, and the like, and the light irradiation time is preferably set such that the integrated amount of light, which is expressed as the product of the intensity of light irradiation in the light wavelength range and the light irradiation time, is from 10 mJ/cm² to 7,000 mJ/cm². The integrated amount of light is more preferably from 200 mJ/cm² to 5,000 mJ/cm² and still more preferably from 500 mJ/cm² to 4,000 mJ/cm². In a case in which the integrated amount of light is in the above range, the curing of the composition smoothly proceeds, and a uniform cured product can be easily obtained.

Heat curing can be combined, if appropriate, before and/or after photocuring.

For example, a two-stage curing can also be performed in which the present composition is impregnated, for example, into a base material having a portion that becomes shaded in the case of light irradiation, the present composition in the area exposed to light is first cured by light irradiation, and then the present composition in the area not exposed to the light is cured by applying heat. Such a base material is not particularly limited, examples thereof include base materials having complex shapes such as fabric-like, fibrous, powdery, porous, and uneven shapes, and two or more of these shapes may be combined.

### (2) Thermal Curing Method

In a case in which the present composition is a thermosetting composition, the curing method and curing conditions thereof are not particularly limited.

The curing temperature is preferably from 80° C. to 200° C., more preferably from 100° C. to 180° C., and still more preferably from 110° C. to 150° C. The curing temperature may be constant or may be increased. Temperature increase and temperature decrease may be combined.

The curing time is selected, if appropriate, depending on the type of the thermal polymerization initiator, the content ratio of other components, and the like, and is preferably from 10 minutes to 360 minutes, more preferably from 30 minutes to 300 minutes, and still more preferably from 60 minutes to 240 minutes. By curing the composition under the aforementioned preferable conditions, a uniform cured film free from blisters, cracks, or the like can be formed.

### (Use Application of Silsesquioxane Derivative etc.)

The silsesquioxane derivative of the invention has a low viscosity and a cured product excellent in hardness can be produced. Since the silsesquioxane derivative has a low viscosity, the coatability without a solvent is excellent, and even in the case of using a solvent, the amount of the solvent used can be reduced.

Since the silsesquioxane derivative of the invention has a low viscosity, the silsesquioxane derivative can be suitably used for use applications requiring a low viscosity. For example, the silsesquioxane derivative can be applied to adhesive applications, printing applications such as inkjet and 3D printing, coating applications, nano-printing applications, and the like. In the case of applying the silsesquioxane derivative to nano-printing applications, the silsesquioxane derivative of the invention has a low viscosity, and thus is excellent in fine transferability. Since the silsesquioxane derivative of the invention can be used without a solvent, the silsesquioxane derivative can be cured as it is after being poured into a mold.

The silsesquioxane derivative of the invention may be used in combination with a filler, other polymerizable compound, or the like. Since the silsesquioxane derivative of the invention has a low viscosity, the silsesquioxane derivative can also be mixed with a large amount of a filler.

Since the cured product of the invention is excellent in hardness, the cured product can be applied to a hard coat, an optical member, and the like. A hard coat excellent in hardness can be obtained by curing a hard coat agent containing the curable composition of the invention. The hard coat agent of the invention may be provided on a base material, and for example, a base material including a hard coat can be obtained by curing the hard coat agent applied onto the base material.

### EXAMPLES

The invention will be specifically described based on Examples and Comparative Examples. The invention is not limited to the following Examples.

### (Measurement of Weight Average Molecular Weight)

The weight average molecular weight (Mw) of the silsesquioxane derivative in each Example and each Comparative Example was measured as follows. Specifically, the weight average molecular weight was determined by performing separation by gel permeation chromatography (HLC-8320GPC manufactured by Tosoh Corporation, hereinafter, abbreviated as “GPC”) at 40° C. in a tetrahydrofuran solvent using a GPC column “TSK gel SuperMultiporeHZ-M” (manufactured by Tosoh Corporation) and calculating the molecular weight in terms of standard polystyrene from the retention time.

### (Measurement of Viscosity)

The viscosity at 25° C. of the silsesquioxane derivative of each Example and each Comparative Example was measured using TVE22H type viscometer manufactured by Toki Sangyo Co., Ltd.

### (Calculation of Molar Ratio of Each Constitutional Unit of Silsesquioxane Derivative)

The molar ratio of each constitutional unit of the silsesquioxane derivative in each Example and each Comparative Example was calculated by subjecting a sample dissolved in deuterated chloroform to ¹H-NMR analysis and further subjecting the sample to ²⁹Si-NMR analysis if necessary.

### Example 1

### (Synthesis of Silsesquioxane Derivative)

(3-Acryloyloxy)propyltrimethoxysilane (167.8 g, 0.716 mol, corresponding to the constitutional unit (b)), 1,3-divinyltetramethyldisiloxane (26.5 g, 0.142 mol, corresponding to the constitutional unit (f)), 2-propanol (166.3 g), and 4-methoxyphenol (0.025 g) were weighed into a 1 L four-necked round bottom flask equipped with a thermometer, a dropping funnel, and a stirring blade, and were well stirred at about 30° C. in a water bath. Separately, 35% hydrochloric acid (1.0 g, 9.6 mmol as hydrogen chloride) and pure water (40.6 g) were mixed to prepare an aqueous solution. The reaction solution was stirred while the prepared aqueous solution was added dropwise to the mixed solution from the dropping funnel over about 1 hour, and then the reaction solution was allowed to stand still at room temperature overnight. Thereafter, while the reaction solution was heated to 60° C., the solvent and the like in the reaction solution were distilled off under reduced pressure to obtain 145.2 g of a silsesquioxane derivative 1 (S1) of a colorless transparent liquid. By ¹H-NMR analysis on S1, it was confirmed that each constitutional unit was quantitatively introduced according to the charging ratio of the raw material. For the synthesized silsesquioxane derivative 1, the viscosity at 25° C. was 400 mPa s, and the weight average molecular weight (Mw) was 1250.

### Examples 2 to 8

Silsesquioxane derivatives 2 to 8 (S2 to S8) were obtained in the same manner as in Example 1, except that the amounts of the raw materials charged were changed as shown in Table 1 instead of Example 1, and the amounts of the solvent and the like were changed, if appropriate. In Examples 6 to 8, as the raw materials constituting the T unit of the silsesquioxane derivative, 3-acryloxypropyltrimethoxysilane (corresponding to the constitutional unit (b)) and 3-methacryloxypropyltrimethoxysilane (corresponding to the constitutional unit (c)) were used.

For the synthesized silsesquioxane derivatives 2 to 8, the molar ratio of each constitutional unit, the viscosity at 25° C., and the weight average molecular weight (Mw) in the silsesquioxane derivative are shown in Table 1.

### Comparative Examples 1 to 5

Silsesquioxane derivatives 9 to 13 (S9 to S13) were obtained in the same manner as in Example 1, except that the amounts of the raw materials charged were changed as shown in Table 1 instead of Example 1, and the amounts of the solvent and the like were changed, if appropriate. In Comparative Example 4, hexamethyldisiloxane (corresponding to the constitutional unit (g)) was used as a raw material constituting the M unit of the silsesquioxane derivative instead of 1,3-divinyltetramethyldisiloxane, and in Comparative Example 5, dimethoxydimethylsilane (corresponding to the constitutional unit (e)) was used as a raw material constituting the D unit of the silsesquioxane derivative.

For the synthesized silsesquioxane derivatives 9 to 13, the molar ratio of each constitutional unit, the viscosity at 25° C., and the weight average molecular weight (Mw) in the silsesquioxane derivative are shown in Table 1.

Each of photocurable compositions 1 to 13 was prepared as follows using each of the silsesquioxane derivatives 1 to 13 synthesized as described above. Evaluation of UV curability and a pencil hardness test were performed using the prepared photocurable compositions 1 to 13. Details are described below.

### (Preparation of Photocurable Composition)

Each of photocurable compositions 1 to 13 (P1 to P13) was prepared by adding 0.03 parts by mass of 2-hydroxy-2-methyl-1-phenylpropane-1-one with respect to 1 part by mass of each of the synthesized silsesquioxane derivatives 1 to 13 and stirring the mixture with a rotation/revolution mixer. In the photocurable compositions 1 to 13, since the solvent and the like are removed by distillation at the time of synthesis of the silsesquioxane derivatives 1 to 13, the photocurable compositions 1 to 13 do not substantially contain a solvent.

### (Evaluation of UV Curability)

Lightning cure LC5 manufactured by Hamamatsu Photonics K.K. was connected to MCR-301 manufactured by Anton Paar GmbH. The behavior of increasing the storage elastic modulus at the time of UV irradiation was recorded by irradiating each photocurable composition prepared as described above with ultraviolet rays (UV) while applying a shear strain, and the UV curing rate (UV curability) of each photocurable composition was evaluated. The storage elastic modulus of each photocurable composition was measured by adding a strain of 0.05% at 1 Hz under the conditions of 25° C. and a nitrogen stream using an 8 mmp parallel plate. Each photocurable composition was irradiated using a high-pressure mercury lamp as a UV light source with only a short wavelength of 365 nm through a heat ray cut filter/a bandpass filter/a neutral density filter. The UV irradiation intensity at this time was 10 mW/cm². The UV curability was evaluated based on the value of storage elastic modulus of each photocurable composition at the time of UV irradiation for 10 seconds according to the following criteria.

The UV curability is excellent in the order of A>B>C. The experimental results are shown in Table 1.

### —Evaluation Criteria—

A: 5.0×10⁶ Pa or more
B: 1.0×10⁶ Pa or more but less than 5.0×10⁶ Pa
C: less than 1.0×10⁶ Pa

### (Production of Photocured Film)

Each of the photocurable compositions 1 to 13 prepared as described above was applied to a polyethylene terephthalate (PET) film or an SPCC steel sheet (cold-rolled steel sheet) washed with acetone. Specifically, each photocurable composition was applied using a No. 10 bar coater in the case of using a PET film and using a No. 4 bar coater in the case of using an SPCC steel sheet, and then the applied photocurable composition was cured by irradiation with ultraviolet rays under the following conditions, thereby producing a photocured film. The film thickness of the photocured film in the case of using a PET film was about 10 μm, and the film thickness of the photocured film in the case of using an SPCC steel sheet was about 5 μm.

### [Ultraviolet Irradiation Conditions]

Lamp: high-pressure mercury lamp
Lamp height: 10 cm
Conveyor speed: 5.75 m/min
Integrated amount of light per pass: 360 mJ/cm² (UV-A)
Atmosphere: in the air
Number of passes: 10 times

### (Pencil Hardness Test)

The photocured film produced as described above was subjected to a pencil hardness test in accordance with JIS K5600-5-4. The pencil hardness test was performed using a 3H pencil in the case of using a PET film as a base material and using an 8H pencil in the case of using an SPCC steel sheet as a base material. Each photocured film was subjected to a scratch test 10 times, and the number of times that no defect occurred in the photocured film was shown in percentage (%). A higher percentage value means a higher hardness of the photocured film. The experimental results are shown in Table 1.

TABLE 1

| | | Compositional ratio (molar ratio) of | | | | | | | | | |
|---|---|---|---|---|---|---|---|---|---|---|---|
| | | constitutional unit of silsesquioxane derivative | | | | | | Weight | | Pencil | |
| | | T unit | | D unit | M unit | | | average | | hardness | |
| | | Consti- | Consti- | Consti- | Consti- | Consti- | | molecular | | no defect/% | |
| | Silsesquioxane | tutional | tutional | tutional | tutional | tutional | Viscosity | weight | UV | | Steel |
| | derivative | unit (b) | unit (c) | unit (e) | unit (f) | unit (g) | (mPa · s) | Mw | curability | PET/3H | sheet/8H |
| Example 1 | S1 | 71.6 | — | — | 28.4 | — | 400 | 1,250 | A | 60 | 60 |
| Example 2 | S2 | 79.1 | — | — | 20.9 | — | 680 | 1,460 | A | 60 | 60 |
| Example 3 | S3 | 83.5 | — | — | 16.5 | — | 1,040 | 1,200 | A | 80 | 80 |
| Example 4 | S4 | 89 | — | — | 11 | — | 820 | 1,200 | A | 90 | 90 |
| Example 5 | S5 | 90 | — | — | 10 | — | 1,110 | 1,320 | A | 90 | 90 |
| Example 6 | S6 | 72 | 18 | — | 10 | — | 910 | 1,210 | A | 100 | 100 |
| Example 7 | S7 | 60 | 29 | — | 11 | — | 820 | 1,270 | A | 100 | 100 |
| Example 8 | S8 | 45 | 45 | — | 10 | — | 730 | 1,530 | B | 100 | 100 |
| Comparative | S9 | 100 | — | — | — | — | 6,000 | 2,330 | A | 100 | 100 |
| Example 1 | | | | | | | | | | | |
| Comparative | S10 | | 100 | — | — | — | 4,000 | 1,660 | C | 100 | 100 |
| Example 2 | | | | | | | | | | | |
| Comparative | S11 | 50 | 50 | — | — | — | 5,000 | 1,990 | B | 100 | 100 |
| Example 3 | | | | | | | | | | | |
| Comparative | S12 | 71.6 | — | — | — | 28.4 | 550 | 1,250 | A | 20 | 20 |
| Example 4 | | | | | | | | | | | |
| Comparative | S13 | 64.2 | — | 35.8 | — | — | 1,620 | 1,970 | A | 0 | 0 |
| Example 5 | | | | | | | | | | | |

As shown in Table 1, the viscosity at 25° C. of each of the silsesquioxane derivatives obtained in Examples 1 to 8 was lower than that of each of Comparative Examples 1 to 3.

The viscosity at 25° C. of each of the silsesquioxane derivatives obtained in Examples 1 to 8 was comparable to that of Comparative Example 4, and a photocured film excellent in hardness could be produced with the silsesquioxane derivatives of Examples 1 to 8.

The viscosity at 25° C. of each of the silsesquioxane derivatives obtained in Examples 1 to 8 was lower than that of Comparative Example 5, and a photocured film excellent in hardness could be produced with the silsesquioxane derivatives of Examples 1 to 8.

The entire contents of the disclosures by Japanese Patent Application No. 2021-195433 filed on Dec. 1, 2021 are incorporated herein by reference.

All the literature, patent application, and technical standards cited herein are also herein incorporated to the same extent as provided for specifically and severally with respect to an individual literature, patent application, and technical standard to the effect that the same should be so incorporated by reference.

1. A silsesquioxane derivative, represented by the following Formula (1): 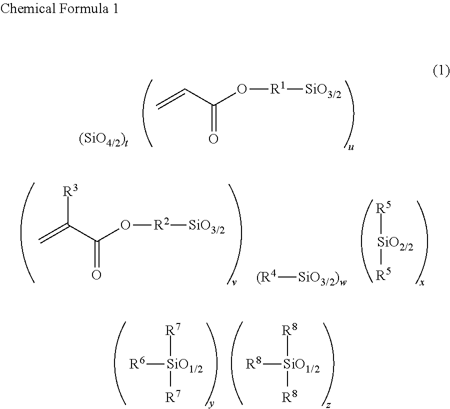
wherein, in Formula (1), each of R1 and R2 is independently an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms, R3 is an alkyl group having from 1 to 6 carbon atoms, each of R4 and R5 is independently a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms, R6 is an organic group having from 2 to 12 carbon atoms and having at least one of an ethylenically unsaturated bond or a carbon-carbon triple bond, each of R7 and R8 is independently an alkyl group having from 1 to 10 carbon atoms, an aryl group having from 6 to 10 carbon atoms, or an aralkyl group having from 7 to 10 carbon atoms, a plurality of R5's present may be the same as or different from each other, a plurality of R7's present may be the same as or different from each other, a plurality of R8's present may be the same as or different from each other, parts of structures of each of R1 to R8 may be independently substituted with a substituent or a halogen atom, y is a positive number, each of t, u, v, w, x, and z is independently 0 or a positive number, and at least one of u or v is a positive number.

2. The silsesquioxane derivative according to claim 1, wherein, in Formula (1), t, x, and z are 0, and 0.01≤y/(u+v+w)≤0.5 is satisfied.

3. The silsesquioxane derivative according to claim 1, wherein, in Formula (1), each of u and v is independently a positive number, and 0<v/u≤1 is satisfied.

4. The silsesquioxane derivative according to claim 1, wherein a viscosity at 25° C. is from 10 mPa·s to 4,000 mPa·s.

5. A curable composition, comprising the silsesquioxane derivative according to claim 1 and a polymerization initiator.

6. A hard coat agent, comprising the curable composition according to claim 5.

7. A cured product, obtained by curing the curable composition according to claim 5.

8. A hard coat, obtained by curing the hard coat agent according to claim 6.

9. A base material, comprising the hard coat according to claim 8.
